(19) United States
(12) Patent Application Publication
(10) Pub. No.: US 2009/0288320 A1
(43) Pub. Date: Nov. 26, 2009

(54) Sphinx System

(76) Inventor: Tawfik El Emam, Alpharetta, GA (US)

Correspondence Address: WILSON DANIEL SWAYZE, JR., 3804 CLEARWATER CT., PLANO, TX, 75025, US

(21) Appl. No.: 12/126,895

(22) Filed: May 25, 2008

(51) Int. Cl. G09F 7/00

(52) U.S. Cl. 40/200

(57) ABSTRACT

An electronic license plate for displaying indicia may include a camera for observing the surroundings of the license plate, a first portion of a screen holder for attaching to a vehicle and holding the electronic license plate, a second portion of the screen holder for attaching to the first portion of the screen holder to hold the electronic license in position and a screen for displaying indicia corresponding to the vehicle. The indicia may be the license plate number, and the indicia may be a insurance name. The indicia may be an insurance expiration year, and the indicia may be an insurance expiration day. The indicia may be an insurance expiration month, and the indicia may be a county. The indicia may be a state, the indicia may be a expiration date of the license plate. The indicia may be the country name, and the indicia may be an expiration year.

### FIELD OF THE INVENTION

The present invention relates to a device and more particularly a license plate including a camera and including indicia to provide valuable information.

### BACKGROUND OF THE INVENTION

U.S. Pat. No. 6,553,131 discloses an intelligent camera system and method for recognizing license plates, including a camera adapted to independently capture a license plate image and recognize the license plate image. The camera includes a processor for managing image data and executing a license plate recognition program device. The license plate recognition program device includes a program for detecting orientation, position, illumination conditions and blurring of the image and accounting for the orientations, position, illumination conditions and blurring of the image to obtain a baseline image of the license plate. A segmenting program for segmenting characters depicted in the baseline image by employing a projection along a horizontal axis of the baseline image to identify positions of the characters. A statistical classifier is adapted for classifying the characters. The classifier recognizes the characters and returns a confidence score based on the probability of properly identifying each character. A memory is included for storing the license plate recognition program and the license plate images taken by an image capture device of the camera.

### SUMMARY OF THE INVENTION

An electronic license plate for displaying indicia may include a camera for observing the surroundings of the license plate, a first portion of a screen holder for attaching to a vehicle and holding the electronic license plate, a second portion of the screen holder for attaching to the first portion of the screen holder to hold the electronic license in position and a screen for displaying indicia corresponding to the vehicle.

The indicia may be the license plate number, and the indicia may be a insurance name.

The indicia may be an insurance expiration year, and the indicia may be an insurance expiration day.

The indicia may be an insurance expiration month, and the indicia may be a county.

The indicia may be a state, the indicia may be a expiration date of the license plate.

The indicia may be the country name, and the indicia may be an expiration year.

### BRIEF DESCRIPTION OF THE DRAWINGS

FIG. 1 illustrates the Sphinx system in accordance with the present invention;

FIG. 2 illustrates a display screen and keyboard in accordance with the teachings of the present invention;

FIG. 3 illustrates a license plate with camera in accordance with the teachings of the present invention;

FIG. 4 illustrates the transmission system of the Sphinx system of the present invention;

FIG. 5 illustrates a portion of the Sphinx screen holder of the present invention;

FIG. 6 illustrates another portion of the Sphinx screen holder of the present invention;

FIG. 7 illustrates a side view of the first portion of the Sphinx screen holder;

FIG. 8 illustrates a side view of the second portion of the Sphinx screen holder.

### DETAILED DESCRIPTION

The Sphinx system is an electronic mobility recognition and road monitoring system which could be if adopted could provide a leading system for safety.

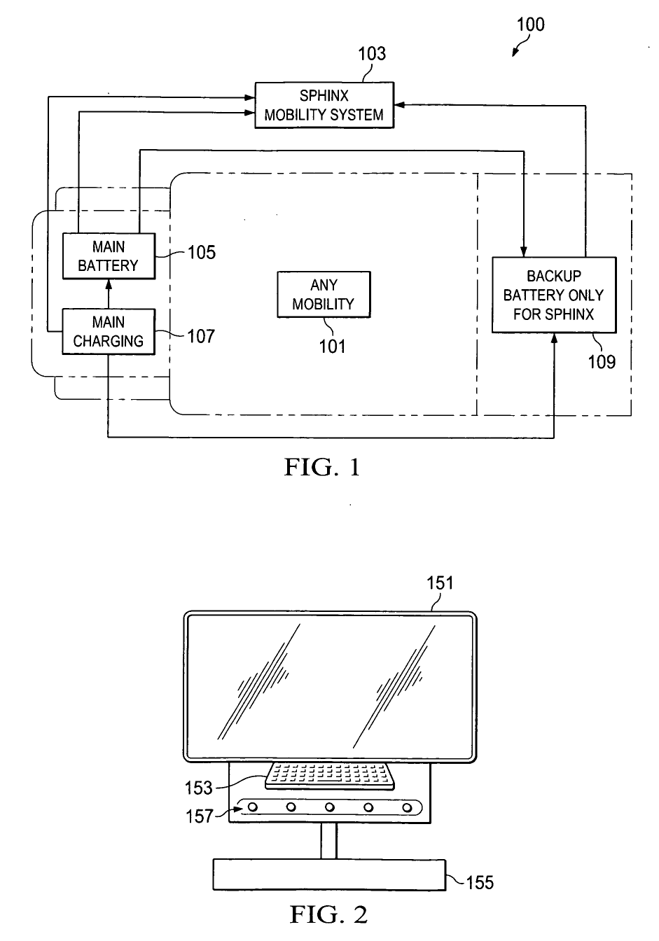

FIG. 1 illustrates the mobility 101 which may be a vehicle such as an automobile, truck, trailer or other such device and which includes a main battery 105 which is connected to a backup battery 109 and a main charging unit 107 the main charging unit 107 and the main battery are connected to the Sphinx mobility system 103. The backup battery 109 is connected to the Sphinx mobility system 103.

FIG. 2 illustrates the screen 151 for the driver of the mobility to displaying information from the Sphinx system and illustrates a keyboard 153 to input information into the Sphinx system. In addition, FIG. 2 illustrates various buttons 157 for the use of the driver of the mobility. One button maybe a hold button, another button maybe a send button, another button maybe a panic button, another button maybe a delete button and yet another button may be a move and select button.

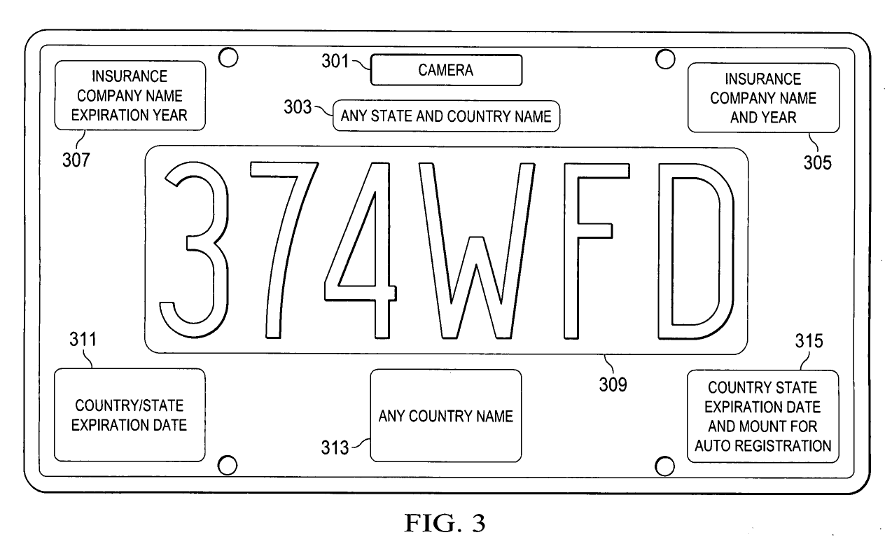

FIG. 3 illustrates a license plate 300 that could be used either on the front or back of the vehicle or both on the front and back of the vehicle. The license plate 300 includes a camera 301 which is shown as being in the top of the Sphinx screen. The camera 301 may be powerful in order to see other objects. Additionally, the screen may include indicia 303 to indicate the state and country name, indicia 305 to display the insurance company name and insurance expiration date, indicia 307 to display the insurance company name and the expiration year, indicia 309 to display the license plate number to identify the vehicle, indicia 311 to display the county or state with the expiration date of the license plate, indicia 313 to display the country name, indicia 315 to display country or state along with the expiration date and month for auto registration. The color of any indicia can change in order to show status information, for instance when an insurance date or registration date has expired the color of that indicia will change to indicate the expired nature. Furthermore, any of the displays may flash in order to draw additional attention to the license plate.

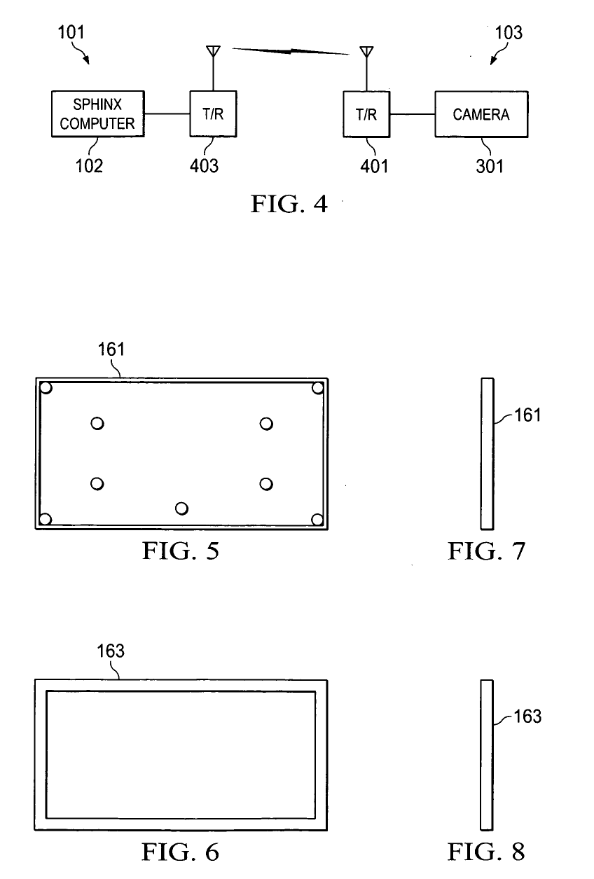

FIG. 4 illustrates the mobility 103 which includes a transmitter and receiver 401 for transmitting camera images from the camera 301 and receiving commands to control the camera 301 and the indicia 303, 305, 307, 309, 311, 313 and 315 being displayed. Correspondingly, FIG. 4 illustrates the Sphinx system 101 which includes a transmitter and receiver 403 which communicates with the Sphinx computer 102.

FIG. 5 illustrates a front view of the first portion of the Sphinx screen holder 161 of the present invention.

FIG. 6 illustrates a front view of the second portion of the Sphinx screen holder 163 of the present invention.

FIG. 7 illustrates a side view of the first portion of the Sphinx screen holder 161 of the present invention.

FIG. 8 illustrates a side view of the second portion of the Sphinx screen holder 163.

The first portion of the Sphinx screen holder 161 and the second portion of the Sphinx screen holder 163 cooperate to hold the license plate 300 in position on the front or back of the mobility.

The present invention will aid the homeland security by providing a system for observing different kinds of vehicles.
The present invention will enable the enforcement of laws strictly by changing the driving habits of all drivers for vehicles including the owner of personal vehicles. Furthermore, it will be applicable to control any law enforcement agent or police officer whether or not the agent or police officer is not on duty or on an official emergency call but using unnecessary speed or abusing his power,
The present invention may change the walking behavior and the roads crossing habits for all people.
The present invention will give a real time road moving or parking video not just still pictures supplemented with additional information from the database about the vehicle under surveillance. Authorized agencies should only be able to get an access to the vehicle computer. Several agencies may work together at the same time. All of these agencies should be supervised by another and different agencies to ensure that all are monitored and recorded for the activity of the agency or agencies after receiving the proper permission from the department who control this system, and no one else should be given this type of access. Even under the circumstances, permission should be obtained to gain access to the computer with the vehicle information and should be subject to very strict monitoring and recording from several other law agencies.
The system of the present invention may be connected to satellite to expand the area of service and should make everything real-time.

Once any country or organization adopts the Sphinx system the benefits will be extended to almost every one riding or walking. In the future, no one will want to drive or move any vehicle without the Sphinx system of the present invention. This Sphinx system may control any vehicle moving or not in any country which has adopted the Sphinx system. Anyone who owns any vehicle may be required to have a Sphinx system installed and the jurisdiction may not allow any vehicle to be without the band system is will include but not limited to cars, trucks, trailers, heavy construction equipment, military equipment and the like.

The present invention will employ a high performance license plate with a camera and a computer chip with a powerful computer all of them are working together as one comprehensive system. The present invention can be developed to meet the requirements and needs of the defense and military establishment.

The electronic license screen plate in conjunction with the camera and chip are connected to the computer box at a safe and very well protected place against even a total damage or loss such as the vehicle explosion, accident or fire. The present invention will be placed inside a safe position in the car which is similar to the black box of an airplane which can survive the crash of the airplane. Consequently, the information can be retrieved to determine all the data during the trip to know what was the cause of the crash.

The new electronic screen will replace the conventional aluminum or metal license plate which will be delegated to part of the history or collective items like any other antiques,

The new screen will be computerize and controlled by many government agencies such as the law enforcement and the agencies who control the traffic system in the country and some authorized companies and lenders who still has interest on the vehicle ( If the law will allow this). The driver or the owner of the vehicle should have no control whatsoever over the Sphinx system of the present invention. The police officer who is driving an official police car and on duty should not change the computer data of any vehicle by himself. The police officer should be only able to download the data concerning the subject vehicle if it is necessary to know what was happening at the time of the accident to the subject vehicle or if the subject vehicle is the cause of accident to other cars. Most of the accidents happen because of other drivers speeding. Swaying or stopping suddenly in front of the subject vehicle without any warning or signal is another cause of accidents.

The police officer can download a copy from the subject car's computer data without deleting any of the original data at the subject car's computer (He'll not be able to do it because it is blocked). This can happen only when the police officer is on duty only and online with both of the subject vehicle and his headquarter after he has entered a special code to the police officer's computer. Furthermore everything should be monitored and recorded at that time to avoid any abuse. The code which the police officer will enter will let him communicate with his/her headquarter about the subject car or any other car like a master key. The police officer will never be able or will be allowed to communicate by himself alone without his headquarter online (The system will not allow him access) and in any event, everything should be recorded.

Every one of these authorized people or agencies should have his/her code plus the user name and password. These could include the user name and password which should be given by the main computer and the highest level departments who are controlling the system with monitoring and recording.

The vehicle computer could be very high in power and memory, or have limited memory and data. The computer power and memory will depend on the value of car or the vehicle or what is the manufacturer or the consumer wants from the vehicle. For military purposes, the requirements could be very high and the computer should have high power and memory, but at the same time any computer with low power and memory should have enough capacity and memory to do the basic job for (Sphinx) system purpose,

The authorized agents who has the power to control the system can update it by increasing or amend the data, Any new amendment should have the date, The time and names of the authorized agency who ordered this amendment and depending on which legislation, But will not be allowed to delete any original data at the car system or the mobility (The system will not delete any data by any one), The authorized agencies can get access to the vehicle computer subject to the following:
1—Any one of these authorized agencies or companies will be monitored and recorded by another several recording system for any thing they'll do it (Same like the 911 System) to make every one protected from any wrong doing or abusing (It could be several monitoring systems)
2—The rules and regulations which will apply to any law enforcement power or police officers if they want to get or download a copy of information from the subject car or mobility will apply the same and equally. Any one who breaks the law including any law enforcement people will be subject to criminal prosecution at the highest court,
3—In any case and especially for lenders and banks and under no circumstances, will anyone be allowed to disable any engine to repossess the car or vehicle without following the legal procedures without first do all regular procedures by sending notes and warning to the Owner of the vehicle that he/she is now liable to lose possession of the vehicle for the defaulted on his loan by using the US mail or any other carrier and sending E-mail. Also they must give him/her the chance and all the usual grace period to make his/her payment to make the loan current again,
4—All notes from the Banks and Lenders to the Defaulted Owner of the vehicle should be send to him/her by certified mail and E-mail, Fax to his/her business and personal address and to E-mail it to his/her home and car or vehicle computer which he can receive it on the screen monitor at his/her vehicle. This will make sure that he/she be able to read it, but in no way, can he delete or erase this note because it will be saved till the Lender or the Bank send him/her a message that they have received the payment and the loan become current again or paid off.
5—Before the Banks or Lenders disable the vehicle or try to repossess the vehicle mobility and after they did every thing legally by sending letters, E-mail and notes to the default Owner the banks or lenders should send a request to the law enforcement authority telling them that they want to disable and repossess the vehicle. After the banks and lenders obtain permission, the law enforcement authority should take the following steps:

All of the processes should be monitored and recorded by several authorized agencies,

To disable any vehicle may involve danger or risky situations like Robbery, Kidnapping, Hijacking, Danger crime or suspect, consequently disabling the vehicle should be handled only by the law enforcement authority only.

Normally to disable a vehicle, the driver or the owner of the vehicle should receive final warning that this mobility will be disabled and repossessed again by the lender, The lender or the bank should send him an E-mail to his mobility's computer screen monitor that the vehicle will be will be disabled within five minutes, and he/she should go and stop at a safe place The lender or banks no way be allowed to disable or stop the vehicle while it is moving, Either the driver will stop it or it is has been parked. The E-mail or the message may be flashing and start counting down the time left to disable the vehicle. This flashing note could be accompanied by a loudly volume emergency sound for warning him and should draw the driver and the passenger attention to stop peacefully without trying to escape or resist. Also, consideration should be taken for the safety of the driver and his passengers,

Since the authorized agency should disable the vehicle, the authorized agency should know if the vehicle is moving or not and the exact location of the vehicle as result of using the Sphinx system. The authorities should disable the vehicle at night or any time the mobility is not moving to avoid any life risk or unforeseen problems.

If the vehicle is operating on the roads and if the authorities must disable the vehicle immediately (like the emergency and risky situation), the vehicle should be disabled by losing speed gradually and by sending a message to the computer of the vehicle to reduce the engine's speed gradually till the vehicle has completely stopped.

If the driver or the owner of the vehicle after all of this warnings to stop the vehicle peacefully and if the driver or the owner is trying to escape or to partly or completely destroy the Sphinx system then the law enforcement will do their job and deal with him in a different way because he is braking the law.

Banks and Lenders can locate the mobility whereabouts using the Sphinx system and disable the engine while it is not moving only to prevent the engine to start again no matter what the driver or the owner of the vehicle will attend to override the Sphinx system to make it start again, The vehicle should not start again without having a special code to be send to the computer of the vehicle to make it operable again. This could be done after the loan paid off or the loan becomes current again. At the same time the Banks and lenders can repossess the mobility while the engine is off and not dangerous for the driver or the passengers.

The present invention with some modification could be applied to many things we want to track with live and obtain real time video pictures at any time including the cargo containers. The container will have all of the information and the specification which usually necessary for shipping. This data will be stored in a small computer with the chip and digital camera in front and back of the container in a similar fashion with the license plate of the vehicle with both the vehicle and container connected with the Sphinx system by the satellite. The Sphinx system of the present invention could be used for military and defense purposes. The Sphinx system of the present invention could be attached to the majority of our weapons and to the arms which we'll ship them to foreign countries or in the USA itself, This will enable the authorities to locate any a piece of military equipment such as Tank, Armor, Canon or missile at any time any place in the world even though if it is hiding underground. The authorities can locate any vehicle, container or any thing has this system at any time in just a push of a button which will help the domestic and defense system. This system can help once the authorities apply it at the inventory at the warehouses for the expensive or sensitive items, Because it will help to eliminate or minimize the number of physical counting which is currently dependent on the existing computer bar scan and the computer list for the inventory which we use it now The present invention will help eliminate theft and miss counting. Everyone will be directly or indirectly benefited.

If the law does not support the Sphinx of the present invention, then the legislatures can make the necessary changes to the laws of this country.

### For The Government and Law Enforcement Agents,

No one can drive or tow any vehicle or trailer without valid insurance because the license plate screen will display the fact that there is no valid insurance. Any authorize or law enforcement agent can stop the vehicle immediately. Also, it will embarrass the driver because everyone will know he has no insurance. Generally, to avoid embarrassment most people will follow and not break the law.

The authorities can locate the vehicle any time at any place in the world with the picture of the vehicle and the license plate. It doesn't matter if the vehicle is running at high speed or if it is parked in hiding place in the day or night at a real time. The present invention provides for digital cameras and special chip to connect the vehicle with the computer and the satellite.

The sphinx system and the computers and cameras may be connected to satellite to record live real-time video which may be retrieved at any time to be used by the authorities. This will allow all the drivers of a vehicle to watch another driver of another vehicle instantaneously, and all drivers are under the watch of the authorities. Furthermore, the authorities can go online and watch any vehicle and the road conditions. No one can drive or tow any vehicle without valid insurance and it can put a lot of careless, speeding drivers or drivers locking driving skills off the road.

The system will eliminate or remove doubt or arguments from lawyers and plaintiffs in unnecessary trials. In addition, it will provide defenders and law enforcement agents with solid proof in order to substantiate or eliminate their claims. This system will protect rights for all others and for any accident. It will stop or reduce criminal activity such as hijacking, kidnapping or stealing with the use of the vehicle because everything can be recorded and retrieved in seconds.

The authorities can disable any vehicle at any time if the driver of the vehicle breaks the law. In addition, the driver will not be able to start the vehicle without the agency approval once the vehicle has been disabled. For example the owner will not field or drive the vehicle if the lender has not received the payments.

The system of the present invention can protect our borders because any vehicle crossing in or out without permission the borders can be detected. Smuggling or trafficking can be eliminated or reduced.

The system of the present invention will reduce or eliminate cameras which have been fixed at one location.

The system of the present invention will allow the cause of an accident to be determined, and mechanical failure or human fault can be determined. The system of the present invention will allow a determination if there was lack of maintenance or a manufacturing defect.

Because the number of uninsured drivers should go down significantly, the insurance rates for the insured drivers should go down due to the fewer number of uninsured drivers.

Software can be added to convert the moving pictures of the accident scene to drawings to show the time and number of cars which were involved in the accident from a number of directions similar to a video game. The drawings could be easily printed out.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

Additional cameras can be added so that the activity inside and out of the vehicle can be recorded. This will provide an indication of the drivers health condition and behavior. It can be used to determine if the driver is dangerous and can determine if the driver was driving recklessly.

This should be used to determine fault in an accident and eliminate extraneous litigation.

The camera may be a powerful storable slim and thin electronic system similar to a computer flat screen.

1. An electronic license plate for displaying indicia, comprising:
a camera for observing the surroundings of the license plate;
a first portion of a screen holder for attaching to a vehicle and holding the electronic license plate;
a second portion of the screen holder for attaching to the first portion of the screen holder to hold the electronic license in position; and
a screen for displaying indicia corresponding to the vehicle.

2. An electronic license plate for displaying indicia as in claim 1, wherein the indicia is the license plate number.

3. An electronic license plate for displaying indicia as in claim 1, wherein the indicia is a insurance name.

4. An electronic license plate for displaying indicia as in claim 1, wherein the indicia is a insurance expiration year.

5. An electronic license plate for displaying indicia as in claim 1, wherein the indicia is a insurance expiration day.

6. An electronic license plate for displaying indicia as in claim 1, wherein the indicia is any insurance expiration month.

7. An electronic license plate for displaying indicia as in claim 1, wherein the indicia is a county.

8. An electronic license plate for displaying indicia as in claim 1, wherein the indicia is a state.

9. An electronic license plate for displaying indicia as in claim 1, wherein the indicia is a expiration date of the license plate.

10. An electronic license plate for displaying indicia as in claim 1, wherein the indicia is the country name.

11. An electronic license plate for displaying indicia as in claim 1, wherein the indicia is an expiration year.
